(19) United States
(12) Patent Application Publication
(10) Pub. No.: US 2015/0324784 A1
(43) Pub. Date: Nov. 12, 2015

(54) SYSTEMS AND METHODS FOR VERIFYING BALANCES ON RETAIL CARDS

(71) Applicant: Brian Culwell, Spring, TX (US)

(72) Inventor: Brian Culwell, Spring, TX (US)

(21) Appl. No.: 14/703,797

(22) Filed: May 4, 2015

Related U.S. Application Data
(60) Provisional application No. 61/989,293, filed on May 6, 2014.

(51) Int. Cl. G06Q 20/34; G06Q 20/20

(52) U.S. Cl. CPC G06Q 20/342; G06Q 20/202

(57) ABSTRACT

Embodiments described herein are directed towards systems and methods for verifying the balances of gift cards associated with different retailers or service providers.

### CROSS-REFERENCE TO RELATED APPLICATIONS

This application claims a benefit of priority under 35 U.S.C. §119 to Provisional Application No. 61/989,293 filed on May 6, 2014, which is fully incorporated herein by reference in its entirety.

### BACKGROUND INFORMATION

1. Field of the Disclosure

Examples of the present disclosure are related to systems and methods for validating balances on gift cards. Specifically, embodiments are related to determining balances on a plurality of gift cards utilizing a mapping of automated attendants for retailers on a computer virtualizing a mobile device.

2. Background

Many retailers or service providers offer customers the option of purchasing gift cards for a predetermined value. The gift cards allow users to subsequently purchase merchandise or services. Frequently, gift cards are purchased as gifts by a gift card buyer. The gift cards are then given to a gift card recipient. Instead of the gift card buyer determining what exact item the gift car recipient may want to purchase, the gift card recipient may use the gift card to purchase desired merchandise or services.

However, a gift card recipient may receive gift cards from retailers that they do not desire to purchase any good or services from. Therefore, a gift card recipient may become the holder of a plurality of gift cards associated with undesirable retailers.

Additionally, the gift cards may have an expiration date, and if the gift cards are not used before the expiration date, then the gift cards may be depleted and/or reduced in value. Over time, a gift card holder may not know the balance for each outstanding gift card being held, and retailers may not know the balance associated with each outstanding gift card and/or an aggregate outstanding balance associated with the distributed gift cards.

Accordingly, needs exist for more efficient and effective systems and methods to verify the balances on gift cards.

### SUMMARY

Embodiments described herein are directed towards systems and methods for verifying the balances on gift cards, wherein the balances of the gift cards associated with different retailers or service providers (referred to hereinafter individually and collectively as “retailer”) may be determined. A gift card may relate to any restricted monetary equivalent that is associated with a retailer, such as a gift card, card including a monetary equivalent associated with a retailer or a plurality of retailers, discount cards, prepaid card, stored value card, loyalty rewards points program, etc. (referred to hereinafter individually and collectively as “gift card”).

Furthermore, embodiments may determine an aggregate balance associated with the outstanding gift cards for different retailers, determine an aggregate balance associated with outstanding gift cards for a retailer, and create a single gift card based on the aggregate balance.

In embodiments, a holder of a plurality of gift cards may desire to purchase goods and/or services from a first retailer. However, when the holder of the gift cards visits the first retailer, the holder of the gift cards may not have a gift card associated with the first retailer, have gift cards with an insufficient amount to purchase the goods and/or services from the first retailer, or not know the balances associated with gift cards associated with the first retailer and/or other retailers. Yet, the holder of the gift cards may have gift cards associated with other retailers with sufficient balances to purchase the goods and/or services. To this end, the holder of the gift cards may desire to know the balances on the different gift cards, and aggregate the outstanding balances of the gift cards associated with different retailers into a single, new gift card associated with the first retailer. Furthermore, a retailer may desire to know the balances associated with outstanding gift cards.

Embodiments may include a gift card server configured to determine an outstanding balance associated with the outstanding gift cards. The gift card server may include an information module, virtualization module, mapping module, and a balance module.

The information module may be configured to receive gift card information associated with at least one gift card to determine the balance associated with each gift card. The gift card information associated with each respective gift card may include a user name, a phone number of the user, retailer information, identification number, protection code, contact information, expiration date, etc.

The virtualization module may be a hardware processing device that is configured to emulate a mobile phone on a hardware computer. The virtualization module may provide a complete substitute for the mobile phone on the hardware computer, wherein the operating system and security protocols of the mobile phone, utilizing the phone number of the user, may be executed of the virtualization module. The virtualization module may emulate a mobile phone of the gift card holder to bypass security protocols, which are typically required by conventional computers which may be bypassed by mobile phones.

The mapping module may include mappings associated with automotive attendants corresponding to a plurality of retailers, wherein the mappings include pre-programmed entries for the automated attendant for each retailer. Data associated with the mapping module may be stored via cache memory at a retailer computing device, which may increase the speed to retrieve gift card balances associated with outstanding gift cards.

The balance module may be configured to utilize the gift card information and the automated attendant's mapping for each retailer to determine the balance for each desired gift card. The balance module may determine balances associated with a plurality of gift cards simultaneously. When simultaneously determine the balances of the plurality of gift cards, the balance module may allocate additional hardware processors, wherein the number of allocated hardware processors may be based on the number of gift cards and/or a number of different retailers associated with the gift cards. When the balances of the plurality of gift cards are determined, the balance module may decommission the hardware processors after determining the balances.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts one topology allowing retailers and/or users to determine balances associated with outstanding gift cards.

FIG. 2 depicts one embodiment of a gift card server.

FIG. 3 depicts a method for verifying balances associated with gift cards

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments disclose systems and methods for verifying the balances of gift cards associated with different retailers. To verify balances of gift cards, embodiments utilize a mapping of the different retailers' automated attendants, information associated with the gift cards, and a public switched telephone network (PSTN). Embodiments may be utilized by users desiring to know the balances associated with their gift cards, and/or retailers desiring to know the balances associated with outstanding gift cards distributed by the retailer.

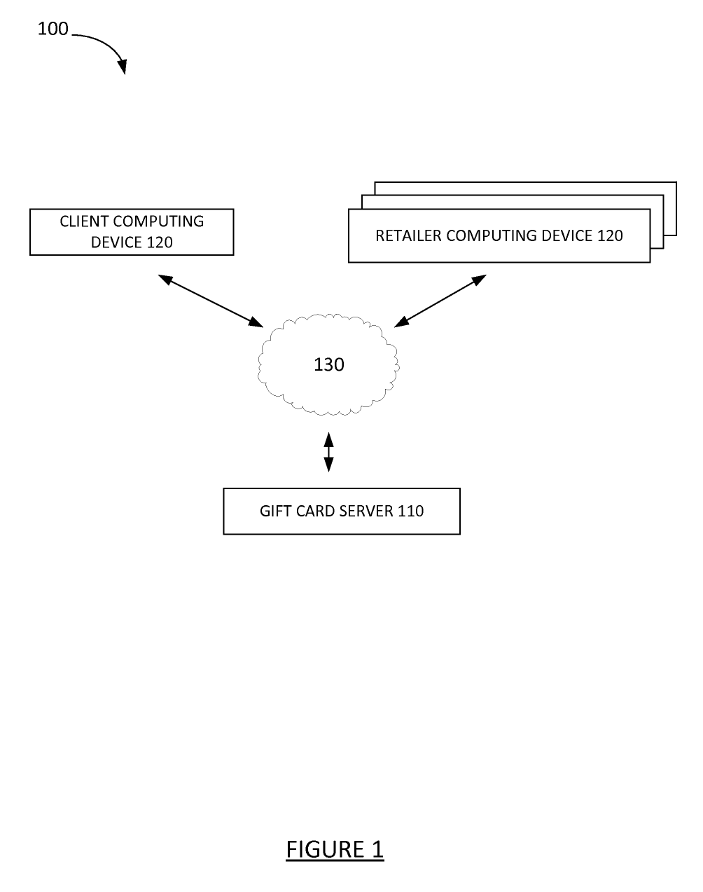

Turning now to FIG. 1, FIG. 1 depicts one topology allowing retailers and/or users to determine balances associated with outstanding gift cards. Topology 100 may include a gift card server 110, client computing device 120, and a retailer computing device 140. The elements depicted in topology 100 may be communicatively coupled to each other over network 130.

Network 130 may be a wired or wireless network such as a PSTN. Network 130 may be comprised of telephone lines, fiber optic cables, internet cables, microwave transmission links, cellular networks, communications satellites, undersea telephone cables, which may be interconnected by switching centers. The switching centers associated with network 130 may allow any telephone or device with a processor to simulate a telephone to communicate with each other. It will be understood that network 130 may be a combination of multiple different kinds of wired or wireless networks, which may include analog telephone systems and/or digital telephone systems.

Gift card server 110 may be a computing device, such as a general hardware platform server configured to support mobile applications, point of sale (POS) devices, software, and the like executed on client computing device 120 and/or retailer computing device 140. Gift card server 110 may include physical computing devices residing at a particular location or may be deployed in a cloud computing network environment.

In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Gift card server 110 may include any combination of one or more computer-usable or computer-readable media. For example, gift card server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Gift card server 110 may also be configured to allocate and provision computing resources based on a processing load on gift card server 110. The processing load may be associated with a number of users simultaneously desiring to verify balances on gift cards, and/or a number of gift cards having their balances verified. Gift card server 110 may be configured to balance a processing load by distributing workloads across multiple computing resources, wherein gift card server 110 may dynamically balance the load using services offered by various hardware devices across network 130. By provisioning load balances associated with different hardware computing devices across network 130, gift card server 110 may increase the speed of verifying balances for gift cards, while also lowering costs associated with verifying balances for gift cards. In embodiments, gift card server 110 may be configured to scale up and/or down based on the processing load by efficiently and dynamically allocating the processing load across nodes evenly.

In embodiments, gift card server 110 may be configured to determine mappings of automated attendant systems for retailer computing devices 140. Based on information associated with gift cards and the mapping of the automated attentive systems, balances for the gift cards may be verified. Gift card server 110 may be configured verify balances for a gift card or a plurality of outstanding gift cards simultaneously over network 130. A retailer may utilize gift card server 110 to determine an aggregate balance a plurality of outstanding gift cards distributed by the retailer, such that the retailer may know the retailer's current financial commitments associated with the disturbed and unused gift cards. A user may utilize gift card server 110 to determine an aggregate balance associated with a plurality of outstanding gift cards associated with different retailers, and aggregate the balances associated with the outstanding gift cards to a new gift card, which may be associated with a single retailer. Therefore, a user may be able to exchange gift cards for retailers that the user does not desire to visit with a gift card associated with a more desirable retailer.

Client computing device 120 may be a laptop computer, desktop computer, smart phone, tablet computer, personal data assistant, or any other type of device with a hardware processor that is configured to process instructions and connect to network 130 and/or other forms of networks. Client computing device 120 may be configured receive gift card information from a user. The gift card information may include a user name, retailer information, identification number, protection code or other security information, contact information, expiration date, etc.

Client computing device 120 may receive gift card information for a single gift card, a plurality of gift cards associated with the same retailer, and/or a plurality of gift cards associated with different retailers. Responsive to receiving the gift card information, client computing device 120 may transmit the gift card information to gift card server 110. Responsive to transmitting the gift card information to gift card server 110, client computing device 120 may receive a balance for gift cards associated with each retailer and/or an aggregate balance associated with a total balance associated with each gift card. A user utilizing client computing device 120 may perform actions on a graphical user interface of client computing device 120 to convert the aggregate balance and/or a portion of the aggregate balance to a new gift card associated with a single retailer

Retailer computing device 140 may be a laptop computer, desktop computer, point of sale computing device, smart phone, tablet computer, personal data assistant, point of sale computing device, or any other type of device with a hardware processor that is configured to process instructions and connect to network 130 and/or other forms of networks. Retailer computing device 140 may be configured to determine balances of outstanding gift cards for a retailer from a user or balances of outstanding gift cards associated with other retailers. Retailer computing device 140 may be configured to receive gift card information from a user or a plurality of users, wherein the gift card information may include a user name, retailer information, identification number, protection code, contact information, expiration date, etc. Responsive to converting the aggregate balance and/or a portion of the aggregate balance to a new gift card associated with a single retailer, retailer computing device 140 may automatically deduct the aggregate balance from a current pending transaction at the retailer.

In embodiments, retailer computing device 140 may receive the gift card information from an internal database associated with the retailer to determine balances associated with outstanding balances for the retailer or from users to determine balances associated with outstanding balances for other retailers. Responsive to receiving the gift card information, retailer computing device 140 may transmit the gift card information to gift card server 110. Responsive to transmitting the gift card information to gift card server 110, retailer computing device 140 may receive a balance for gift cards associated with different retailers for a user, balances for gift cards owned by users distributed by the retailer, and/or an aggregate balances for a plurality of outstanding gift cards distributed by the retailer.

In embodiments, retailer computing device 140 may also be configured to receive and store mapping information associated with automated attendants for retailers in cache memory. The mapping information may be allocated in cache memory at retailer computing device 140, wherein the mapping information includes mappings of automated attendants associated with a plurality of retailers. Responsive to retailer computing device 140 receiving the mapping information associated with any retailer, the mapping information may be stored within the cache of retailer computing device 140. Utilizing the cached map, retailer computing device 140 may initiate a process to determine the outstanding balance of the gift card, while simultaneously receiving gift card information from gift card server 110.

Utilizing gift card server 110 and network 130, a retailer and/or user may be able to determine the balances of a plurality of gift cards associated with different retailers simultaneously. Therefore, a retailer may determine any number of requests for balances for gift cards over network 130, and return the balances quickly. Accordingly, cost and time associated with verifying balances on gift cards may be greatly reduced.

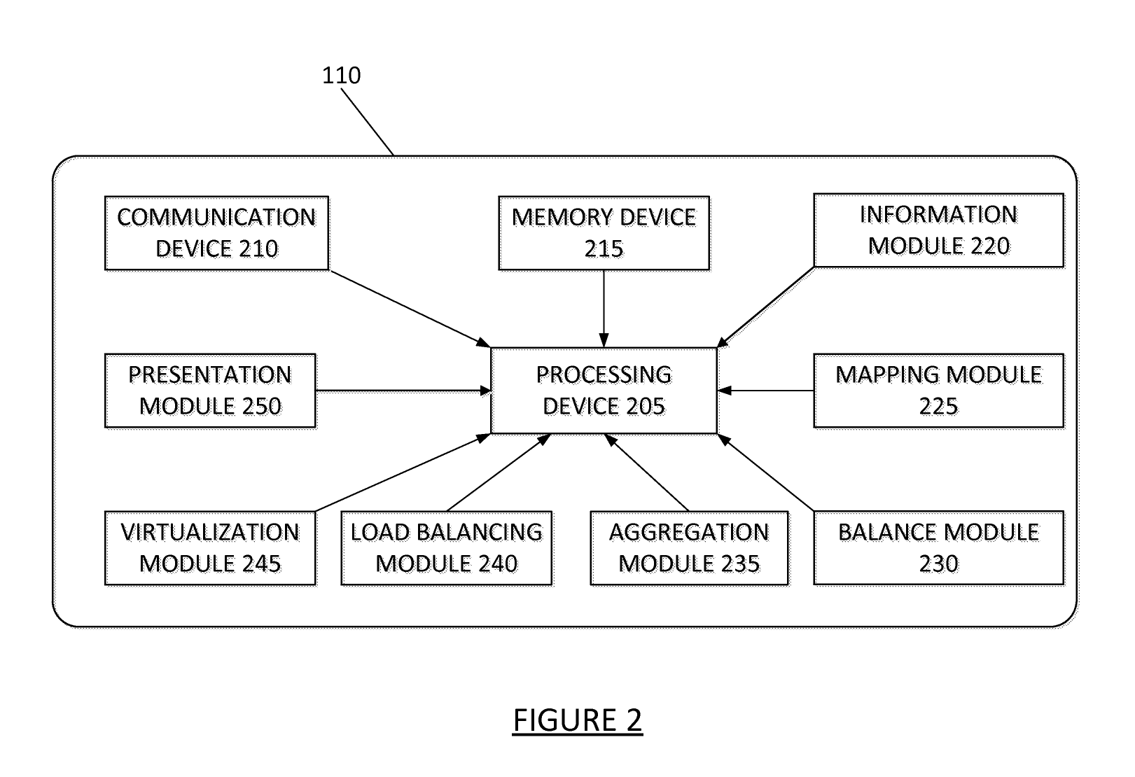

FIG. 2 depicts one embodiment of gift card server 110. One skilled in the art will appreciate that certain elements associated with gift card server 110 may be locally stored at client computing device 110. Accordingly, elements described below may also be stored at client computing device 110.

Gift card server 110 may include a processing device 205, a communication device 210, a memory device 215, an information module 220, mapping module 225, balance module 230, an aggregation module 235, a load balancing module 240, a virtualization module 245, and a presentation module 250. In embodiments, gift card server 110 and/or portions of gift card server 110 may be embedded within a retailer computing device 140. Accordingly, the balances of gift cards and/or aggregating gift cards may be completed at a point of sale device, while a customer is completing a transaction.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of gift card server 110 or software associated with other elements of gift card server 110.

Communication device 210 may be a device that gift card server 110 to communicate with another device over network 130. Communication device 210 may include one or more wireless transceivers for performing wireless communication and/or one or more communication ports for performing wired communication over a PSTN. Communication device 210 may be configured to communicate data over a plurality of different standard and/or protocols.

Memory device 215 may be a device that stores data generated or received by gift card server 110. Memory device 215 may include, but is not limited to a hard disc drive, an optical disc drive, and/or a flash memory drive. In embodiments, memory device 215 may be configured to store information received from a client computing device 120 and/or retailer computing device 140. The information stored within memory device 215 may be accessed by processing device 205, communication device 210, and/or modules 220, 225, 230, 235, 240

Information module 220 may be a hardware processing device configured to receive gift card information from a client computing device 120 and/or a retailer computing device 140. The gift card information associated with each respective gift card may include a user name, retailer information, identification number, protection code, contact information, expiration date, etc. In embodiments, different retailers may have different information associated with their gift cards. For example, a first retailer may have a gift card with an identification number being a first number of digits, and a second retailer may have a second gift card having a second number of digits. Furthermore, different retailers may present gift card information in different forms, such as bar codes, Q-R codes, coupons, digital downloads, rebates, etc.

Mapping module 225 may be a hardware processing device configured to determine and store a mapping (e.g. programming) for automated attendants associated with different retailers. The automated attendants may be processes allowing telephone calls to be automatically transferred and processed without the intervention of an operators or receptionists. An automated attendant associated with a first retailer may include a menu system with different levels of processes. Furthermore, a menu may include a first level process to transfer the telephone call to the correct department, a second level process to enter related information, and a third level process to receive desired information. For example, a first level process associated with an automated attended may include the following options for sales press 1, for service press 2, for balance checking on gift cards press 3, etc. Responsive to the automated attendant receiving information indicating that the user desires to receive information to check the balance on a gift card by receiving information associated with the corresponding number (e.g. “3”), the menu may continue to a second level process. The second level process may require a user to enter information associated with a gift card (e.g. the gift card number, expiration date, etc.). Responsive to receiving the required gift card information, the menu may continue to a third level process, wherein the third level process may audibly communicate the balance of the gift card. In embodiments, once client computing device has requested a mapping associated with a retailer, the mapping associated with the specific retailer may be stored locally at the client computing device, such that another request for the mapping may not be necessary. Accordingly, time and bandwidth associated with round trip delays may be reduced.

In embodiments, different retailers may have different menus with different levels of processes, and/or require different information be received at different points in time. Therefore, mapping module 225 may store the different menus associated with different retailers, such that balance module 230 may utilize the stored mappings to determine balances on different gift cards distributed by different retailers. In embodiments, when an automated attendant for a retailer includes a live operator who answers a request or audio information is required, mapping module 225 may include a text to speech and/or a speech to text program. The programs may be mapped to the automated attendant to transmit the formatted gift card information, receive an audible response from the operator, convert the audible response into a desired format (e.g. text), and store the formatted response. Responsive to a retailer computing device 140, requesting a mapping associated with a retailer, mapping module 225 may transmit the mapping information to the retailer computing device 140. The retailer computing device 140 may store the mapping information within cache memory, such that the time to determine the balance of a gift card by retailer computing device 140 may be reduced.

Balance module 230 may be a hardware processing device configured to determine balances on gift cards. Balance module 230 may verify balances on gift cards by utilizing received gift card information received by information module 220 and mappings of different retailers automated attendants determined by mapping module 220. In embodiments, balance module 230 may be configured to determine a retailer associated with a gift card based on the received gift card information. For example, balance module 230 may determine the retailer associated with the gift card based on the gift card identifying the retailer, the number of digits associated with an identification for a gift card, etc. Responsive to determining a retailer associated with a gift card, balance module 230 may utilize the corresponding mapping of the automated attendant associated with the retailer and transmit the corresponding gift card information at relevant process levels.

When transmitting the relevant gift card information at corresponding process levels, balance module 230 may receive a balance associated with the gift card. The received balance may be a digital numerical amount and/or an audible amount. If the received balance is presented as an audible amount, balance module 230 may be configured to convert the audible balance into a digital numerical amount. Balance module 230 may be configured to store the digital numerical amount in a database associated with a user and/or a database associated with a retailer, wherein balance module 230 may store the information in different databases based on if a user or retailer transmitted the gift card information. In embodiments, balance module 230 may be configured to transmit the balances associated with specific retailers individually, which may be locally stored at a client computing device 110 within an independent data store. The independent balances may be stored within a cache memory of client computing device 110.

Aggregation module 235 may be a hardware processing device configured to receive the digital numerical amount associated with an outstanding gift card, store the numerical amount, and add the numerical amount associated with a corresponding database entry. In embodiments, responsive to a user entering information associated with a plurality of gift cards from the same and/or different retailer, aggregation module 235 may be configured to aggregate the outstanding balances associated with the gift cards, and store the amount in an entry associated with the user. Therefore, aggregation module 235 may be configured to determine the aggregate total balance associated with each outstanding gift card owned by the user. Furthermore, aggregation module 235 may be configured to transfer the outstanding balances associated with the plurality of gifts cards associated with different retailers onto a single gift card. In embodiments, responsive to aggregating the outstanding gift cards associated with different retailers, the single gift card may be a new gift card. The new gift card may include new information including: a new user name, retailer information, identification number, protection code, contact information, expiration date, etc. The protection code may be a new security token that is generated by aggregation module, so the user may utilize the new gift card. When aggregating the plurality of gift cards associated with different retailers together, aggregation module 235 may assign a balance value associated with an outstanding gift card, wherein the balance value may associated with the current outstanding balance of the gift card, expiration date of the gift card, retailer associated with the gift card, etc. Aggregation module 235 may operate as a third party broker, and perform transactions to clear the balance associated with the previous retailer and create a balance associated with the current retailer based on the determine balance value.

In embodiments, aggregation module 235 may be configured to determine the aggregate balance associated with balances for all or a subset of outstanding gift cards for a specific retailer. Aggregate module 235 may be configured to aggregate the balances on each outstanding gift card for a specific retailer for all issued gift cards, store the aggregate balance in an entry of a database associated with the specific retailer, and present the aggregate balance associated with the specific retailer. Additionally, aggregate module 235 may be configured to apply business rules associated with the expiration dates and corresponding devaluations of the gift cards, wherein aggregate module 235 may determine a possible future aggregate balance for the outstanding gift cards if the gift cards are not used. Therefore, the specific retailer may know the retailer's current and/or future financial commitments associated with the outstanding gift cards.

Load balancing module 240 may be configured to balance a processing load of gift card server 110 across different hardware elements on network 130. The load may be balanced by allocating, scaling, adding, and deleting, and provisioning hardware processing resources based on the processing load on gift card server 110. The processing load may be associated with a number of users simultaneously desiring to verify balances on gift cards, and/or a number of gift cards having their balances verified. Load balancing module 240 may be configured to balance a processing load by distributing workloads across multiple computing resources, wherein gift card server 110 may dynamically balance the load using services offered by various hardware devices across network 130. By provisioning load balances associated with different hardware computing devices across network 130, Load balancing module 240 may increase the speed of verifying balances for gift cards, while also lowering costs associated with verifying balances for gift cards. In embodiments, Load balancing module 240 may be configured to scale up and/or down based on the processing load by efficiently and dynamically allocating the processing load across nodes evenly. To this end, when gift card server 110 has an increased load, load balancing module 240 may be configured to increase the amount of hardware processors allocated to the workload of gift card server 110, and when gift card server 110 has a decreased load, load balancing module 240 may be configured to decrease the amount of hardware processors allocated to the workload of gift card server 110. In further embodiments, the allocation or decommissioning of hardware processors associated with the load of gift card server 110 may be scheduled, wherein during normal business hours additional servers may be allocated to the workload, and during non-business hours the number of servers allocated to the workload may be reduced.

Virtualization module 245 may be a hardware processing device that is configured to emulate a smart phone on a hardware computer. The virtualization module may provide a complete substitute for the smart phone on the hardware computer, wherein the operating system and security protocols of the smart phone may be executed of the virtualization module. Accordingly, virtualization module 245 may operate an operating system and system protocols of client computing device 120, wherein client computing device 120 is a mobile phone, on gift card server 110. Virtualization module may 245 emulate a mobile phone of the gift card holder to bypass security protocols, which are typically required by conventional computers which may be bypassed by smart phones. Virtualization module 245 may divide a disk image into logical parts that may be individually managed by processing device 205, wherein the layering include physical partitions stored on gift card server 110, client-based virtual machines with partitions stored on client computing device, and cloud based partitions stored on gift card server 110.

Presentation module 250 may be a hardware processing device configured to transmit content to be displayed at client computing device 120 and retailer computing device 140. Presentation module 250 may be configured to transmit an aggregate amount of balances of gift cards for different retailers owned by user to client computing device. Presentation module 250 an aggregate amount of balances of gift cards for a retailer from a plurality of users and/or an aggregate amount of balances of gift cards for different retailers from at least one user.

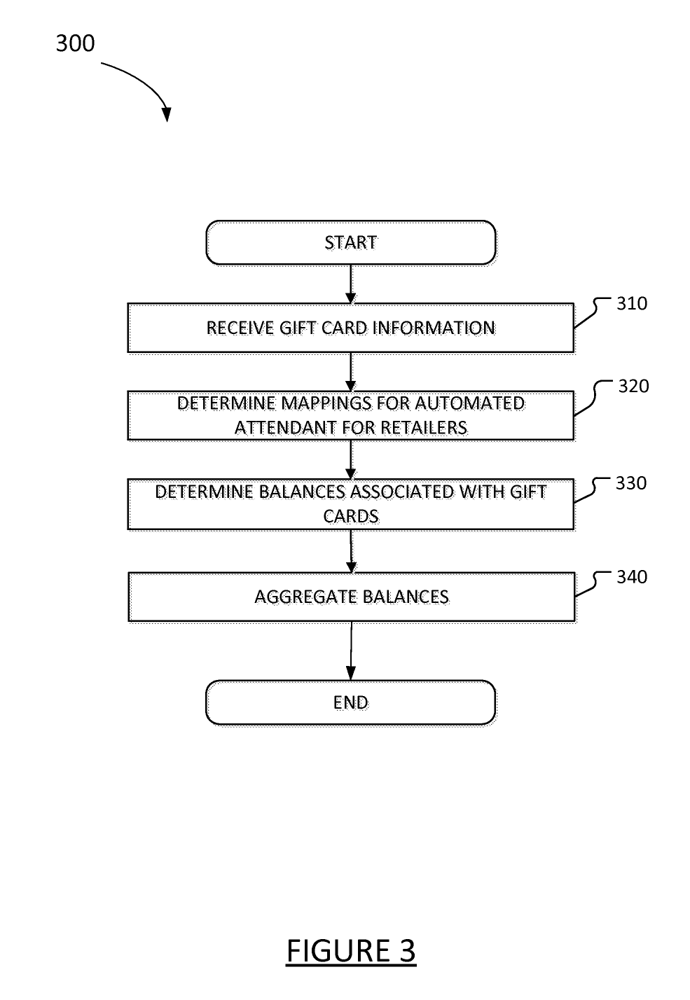

FIG. 3 illustrates a method 300 for verifying balances associated with gift cards. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 500.

At operation 310, gift card information may be received. The received gift card information may include a user name, retailer information, identification number, protection code, contact information, expiration date, etc. The gift card information may be received from a client computing device and/or a retailer computing device. Operation 310 may be performed by an information module that is the same as or similar to information module 220, in accordance with one or more implementations.

At operation 320, a mapping for an automated attendant associated with retailers may be determined. The mapping may include processes allowing telephone calls to be automatically transferred and processed without the intervention of an operator or receptionist, wherein each retailer may have a different mapping. In embodiments, the mapping may be determined by a user programming the mapping on a user interface associated with a computing device. Operation 320 may be performed by a mapping module that is the same as or similar to mapping module 225, in accordance with one or more implementations.

At operation 330, a balance for the gift cards associated with the received gift card information may be determined. The balance may be determined based on the gift card information and the mappings corresponding to different retailers. Operation 330 may be performed by a balance module that is the same as or similar to balance module 230, in accordance with one or more implementations

At operation 340, the balances associated with the gift cards may be aggregated together. The aggregate balance may be associated with a retailer's financial commitment associated with the outstanding gift cards. Operation 340 may be performed by an aggregation module that is the same as or similar to aggregation module 235, in accordance with one or more implementations

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A point of sale device for verifying balances on gift cards and aggregating the balances to a new gift card, the point of sale device comprising:
an information processing device configured to receive gift card information associated with a first gift card, the gift card information including retailer information identifying a retailer associated with the gift card, a gift card number, and a phone number;
a virtualization module configured to emulates processing of a mobile phone on the point of sale device, wherein the virtualization module emulates the processing of the mobile phone based on the phone number;
a mapping hardware processing device configured to store mappings of automated attendants associated with a plurality of retailers, the mapping being stored within cache memory of the point of sale device;
a balance hardware processing device configured to determine a balance of the first gift card based on the mapping of the automated attendant corresponding to the retailer information and the gift card number.

2. The point of sale device of claim 1, further comprising:
a load balancing processing device configured to allocate and decommission hardware processing resources based on a processing load, wherein the processing load is based on a number of requests for determining balances of gift cards.

3. The point of sale device of claim 1, wherein the balance hardware processing device is configured to determine balances of a plurality of gift cards based on the mapping of the automated attendants from the plurality of retailers, the plurality of gift cards being associated with different retailers having different mappings of automated attendants; and
an aggregation module is configured to aggregate the balances of the plurality of gift cards and issue a new gift, the new gift card including new gift card information and being associated with a retailer corresponding to the point of sale device.

4. The point of sale device of claim 1, wherein the balance hardware processing device is configured to determine the balances of the plurality of gift cards simultaneously.

5. The point of sale device of claim 1, wherein the balance hardware processing device is configured to determine a total outstanding balance associated with all of the outstanding balances for a plurality of outstanding gift cards associated with the retailer.

6. The point of sale device of claim 5, wherein the balance hardware processing device is configured to determine expiration dates associated with each of the outstanding gift cards, and determine a future aggregate balance at different points in time based on the expiration dates associated with each of the outstanding gift cards and the outstanding balances of the plurality of outstanding gift cards.

7. The point of sale device of claim 1, wherein the mapping hardware computing device is configured to determine the balance associated with the first gift card without an operator.

8. The point of sale device of claim 1, wherein the balance hardware processing device is configured to determine a balance of the first gift card when a gift card holder is completing a transaction at a first retailer.

9. The point of sale device of claim 8, wherein the first retailer is associated with the first gift card.

10. The point of sale device of claim 8, wherein the first retailer is not associated with the first gift card.

11. A method for verifying balances on gift cards and aggregating the balances to a new gift card, the method comprising:
receiving gift card information, at a point of sale device, associated with a first gift card, the gift card information including retailer information identifying a retailer associated with the gift card, a gift card number, and a phone number;
emulating processing of a mobile phone on the point of sale device, wherein the virtualization module emulates the processing of the mobile phone based on the phone number;
storing mappings of automated attendants associated with a plurality of retailers, the mapping being stored within cache memory of the point of sale device;
determining a balance of the first gift card based on the mapping of the automated attendant corresponding to the retailer information and the gift card number.

12. The method of claim 11, further comprising:
allocating and decommissioning hardware processing resources based on a processing load, wherein the processing load is based on a number of requests for determining balances of gift cards.

13. The method of claim 11, further comprising:
determining balances of a plurality of gift cards based on the mapping of the automated attendants from the plurality of retailers, the plurality of gift cards being associated with different retailers having different mappings of automated attendants; and
aggregating the balances of the plurality of gift cards; and
issuing a new gift, the new gift card including new gift card information and being associated with a retailer corresponding to the point of sale device.

14. The method of claim 11, wherein the determining the balances of the plurality of gift cards occurs simultaneously.

15. The method of claim 11, further comprising:
determining a total outstanding balance associated with all of the outstanding balances for a plurality of outstanding gift cards associated with the retailer.

16. The method of claim 15, further comprising:
determining expiration dates associated with each of the outstanding gift cards; determining a future aggregate balance at different points in time based on the expiration dates associated with each of the outstanding gift cards and the outstanding balances of the plurality of outstanding gift cards.

17. The method of claim 11, further comprising:
determining the balance associated with the first gift card without an operator.

18. The method of claim 11, further comprising:
determining a balance of the first gift card when a gift card holder is completing a transaction at a first retailer.

19. The method of claim 18, wherein the first retailer is associated with the first gift card.

20. The method of claim 18, wherein the first retailer is not associated with the first gift card.
